(19) United States
(12) Patent Application Publication
(10) Pub. No.: US 2007/0079294 A1
(43) Pub. Date: Apr. 5, 2007

(54) Profiling using a user-level control mechanism

(76) Inventors: Robert Knight, Mahomet, IL (US); Chris J. Newburn, South Beloit, IL (US); Anton Chernoff, Littleton, MA (US); Hong Wang, Santa Clara, CA (US); Xiang Zou, Beaverton, OR (US); Robert Geva, Cupertino, CA (US)

Correspondence Address: TROP PRUNER & HU, PC, 1616 S. VOSS ROAD, SUITE 750, HOUSTON, TX, 77057-2631, US

(21) Appl. No.: 11/240,703

(22) Filed: Sep. 30, 2005

(51) Int. Cl. G06F 9/44

(52) U.S. Cl. 717/130

(57) ABSTRACT

In one embodiment, the present invention is directed to a system that includes an optimization unit to optimize a code segment, and a profiler coupled to the optimization unit. The optimization unit may include a compiler and a profile controller. Further, the profiler may be used to request programming of a channel with a scenario for collection of profile data during execution of the code segment. Other embodiments are described and claimed.

### BACKGROUND

Embodiments of the present invention relate to computer systems and more particularly to effective use of resources of such a system.

Computer systems execute various software programs using different hardware resources of the system, including a processor, memory and other such components. A processor itself includes various resources including one or more execution cores, cache memories, hardware registers, and the like. Certain processors also include hardware performance counters that are used to count events or actions occurring during program execution. For example, certain processors include counters for counting memory accesses, cache misses, instructions executed and the like. Additionally, performance monitors may also exist in software to monitor execution of one or more software programs.

Together, such counters and monitors can be used according to different usage models. As an example, they may be used during compilation and other optimization activities to improve code execution based upon profile information obtained during program execution. The collection of profile information for use in feedback-directed dynamic optimization has grown tremendously in importance in recent years, as significant amounts of new software is being written in a managed language. Traditional feedback-directed optimization techniques rely on instrumenting a program to collect profiles, requiring compilation to insert hooks to collect the data, running the program with a high overhead, and then recompiling with the profile information to obtain a production binary. Instrumentation code cannot collect information about a behavior that it cannot directly observe, such as hardware memory cache behavior. In another usage model, upon occurrence of an event in a counter or monitor during program execution, one or more helper threads may be called. Such helper threads are software routines that are called by a calling program to improve execution, such as to prefetch data from memory or perform another activity to improve program execution.

Oftentimes, these resources are used inefficiently, and furthermore use of such resources in the different usage models can conflict. A need thus exists for improved manners of obtaining and using monitors and performance information in these different usage models.

### BRIEF DESCRIPTION OF THE DRAWINGS

FIG. 1 is a block diagram of a processor in accordance with one embodiment of the present invention.

FIG. 2 is a block diagram of a hardware implementation of a plurality of channels in accordance with an embodiment of the present invention.

FIG. 3 is a block diagram of hardware/software interaction in a system in accordance with one embodiment of the present invention.

FIG. 4 is a flow diagram of a method in accordance with one embodiment of the present invention.

FIG. 5 is a flow diagram of a method for using programmed channels in accordance with an embodiment of the present invention.

FIG. 6 is a flow diagram of a method of executing a service routine in accordance with one embodiment of the present invention.

FIG. 7 is a block diagram of a multiprocessor system in accordance with an embodiment of the present invention.

### DETAILED DESCRIPTION

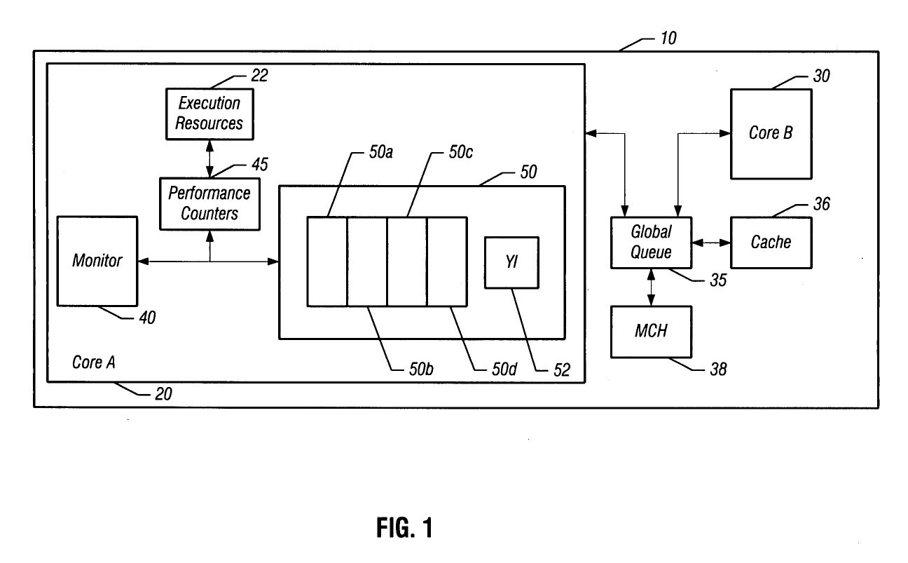

Referring now to FIG. 1, shown is a block diagram of a processor in accordance with one embodiment of the present invention. In some embodiments, processor 10 may be a chip multiprocessor (CMP) or another multiprocessor unit. As shown in FIG. 1, a first core 20 and a second core 30 may be used to execute instructions of various software threads. Also shown in FIG. 1, first core 20 includes a monitor 40 that may be used to manage resources and control a plurality of channels 50a-50d of the core. First core 20 may further include execution resources 22 which may include, for example, a pipeline of the core and other execution units. First core 20 may further include a plurality of performance counters 45 coupled to execution resources 22, which may be used to count various actions or events within these resources. In such manner, performance counters 45 may detect particular conditions and/or counts and monitor various architectural and/or microarchitectural events, which are then communicated to monitor 40, for example.

Monitor 40 may include various programmable logic, software and/or firmware to track activities in performance counters 45 and channels 50a-50d. Channels 50a-50d may be register-based storage media, in one embodiment. A channel is an architectural state that includes a specification and occurrence information for a scenario, as will be discussed below. In various embodiments, a core may include one or more channels. There may be one or more channels per software thread, and channels may be virtualized per software thread. Channels 50a-50d may be programmed by monitor 40 for various usage models, including performance-guided optimization (PGOs) or in connection with improved program performance via the use of helper threads or the like.

While shown as including four such channels in the embodiment of FIG. 1, in other embodiments more or fewer such channels may be present. Further, while shown only in first core 20 for ease of illustration, channels may be present in multiple processor cores. A yield indicator 52 may be associated with channels 50a-50d. In various embodiments, yield indicator 52 may act as a lock to prevent occurrence of one or more yield events (to be discussed further below) while yield indicator 52 is in a set condition (for example).

Still referring to FIG. 1, processor 10 may include additional components, such as a global queue 35 coupled between first core 20 and second core 30. Global queue 35 may be used to provide various control functions for processor 10. For example, global queue 35 may include a snoop filter and other logic to handle interactions between multiple cores within processor 10. As further shown in FIG. 1, a cache memory 36 may act as a last level cache (LLC). Still further, processor 10 may include a memory controller hub (MCH) 38 to control interaction between processor 10 and a memory coupled thereto, such as a dynamic random access memory (DRAM) (not shown in FIG. 1). While shown with these limited components in FIG. 1 a processor may include many other components and resources. Furthermore, at least some of the components shown in FIG. 1 may include hardware or firmware resources or any combination of hardware, software and/or firmware.

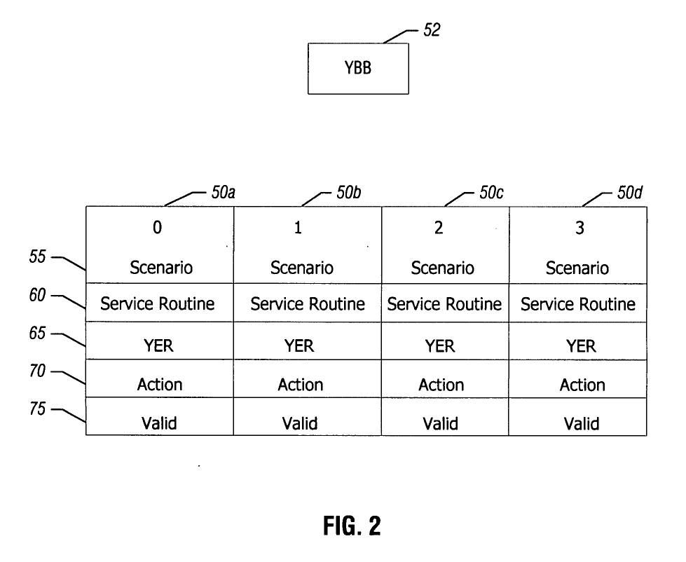

Referring now to FIG. 2, shown is a block diagram of a hardware implementation of a plurality of channels in accordance with an embodiment of the present invention. As shown in FIG. 2, channels 50a-50d may correspond to channels 0-3, respectively, as viewed by software. In the embodiment of FIG. 2, channel identifiers (IDs) 0-3 may identify a channel programmed with a specific scenario, and may correspond to a channel's relative priority. In various embodiments, the channel ID may also identify a sequence (i.e., priority) of service routine execution when multiple scenarios trigger on the same instruction, although the scope of the present invention is not so limited. As shown in FIG. 2, each channel, when programmed, includes a scenario segment 55, a service routine segment 60, a yield event request (YER) segment 65, an action segment 70, and a valid segment 75. While shown with this particular implementation in the embodiment of FIG. 2, it is to be understood that in other embodiments, additional or different information may be stored in programmed channels.

A scenario defines a composite condition. In other words, a scenario defines one or more performance events or conditions that may occur during execution of instructions in a processor. These events or conditions, which may be a single event or a set of events or conditions, may be architectural events, microarchitectural events or a combination thereof, in various embodiments. Scenarios thus define what can be detected and stored in hardware, and presented to software. A scenario includes a triggering condition, such as the occurrence of multiple conditions during program execution. While these multiple conditions may vary, in some embodiments the conditions may relate to low progress indicators and/or other microarchitectural or structural details of actions occurring in execution resources 22, for example. The scenario may also define processor state data available for collection, reflecting the state of the processor at the time of the trigger. In various embodiments, scenarios may be hard-coded into a processor. In these embodiments, scenarios that are supported by a specific processor may be discovered via an identification instruction (e.g., the CPUID instruction in an x86 instruction set architecture (ISA), hereafter an “x86 ISA”).

A service routine is a per scenario function that is executed when a yield event occurs. As shown in FIG. 2, each channel may include a service routine segment 60 including the address of its associated service routine. A yield event is an architectural event that transfers execution of a currently running execution stream to a scenario's associated service routine. In various embodiments, a yield event occurs when a scenario's triggering condition is met. In various embodiments, the monitor may initiate execution of the service routine upon occurrence of the yield event. When the service routine finishes, the previously executing instruction stream resumes execution. The yield event request (YER) stored in YER segment 65 is a per channel bit indicating that the channel's associated scenario has triggered and that a yield event is pending. A channel's action bits stored in action segment 70 define the behavior of the channel when its associated scenario triggers. Finally, valid segment 75 may indicate the state of programming of the associated channel (i.e., whether the channel is programmed).

Still referring to FIG. 2, a yield indicator 52, also referred to herein as a yield block bit (YBB), is associated with channels 50a-50d. Yield indicator 52 may be a per software thread lock. When yield indicator 52 is set, all channels associated with that privilege level are frozen. That is, when yield indicator 52 is set, associated channels cannot yield, nor can their associated scenario's triggering condition(s) be evaluated (e.g., counted).

Software programs hardware with a scenario, which causes the hardware to detect predefined events and collect predefined information. The software may thus configure the hardware initially, and then start, pause, resume, and stop collections. In some embodiments, a separate software routine, i.e., a service routine may perform data collection. Sampling collection mechanisms may include initializing a channel, collecting a profile sample and/or reading an event count, and modifying a previously programmed channel to pause, resume, stop, or modify a scenario's current parameters.

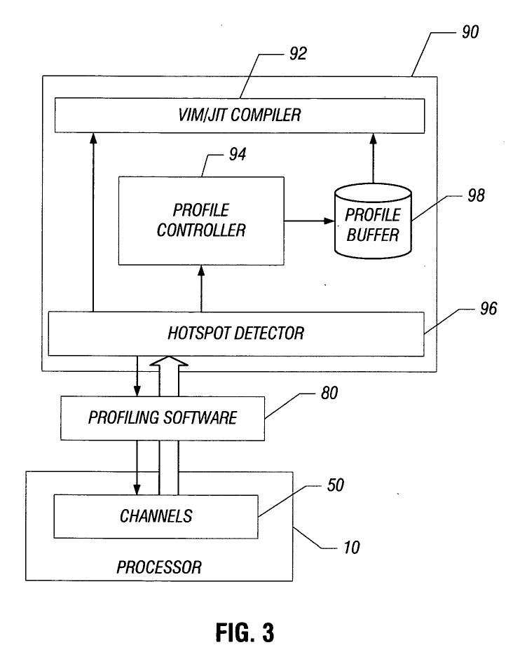

Returning now to FIG. 3, shown is a block diagram illustrating hardware/software interaction in a system in accordance with one embodiment of the present invention. As shown in FIG. 3, the hardware includes a processor 10 that has a plurality of channels 50. In some embodiments, only a single channel may be present. As an example, processor 10 may correspond to processor 10 of FIG. 1. Profiling software 80 may communicate with processor 10 to implement collection of data using channels 50. Thus as shown in FIG. 3, profiling software 80 sends configuration/control signals to processor 10. In turn, processor 10 performs profile activities, e.g., counting in accordance with the programmed channels. When requested by profiling software 80, processor 10 may communicate profile data which in turn is provided to a dynamic profile-guided optimization (DPGO) system 90.

As shown in FIG. 3, DPGO system 90 may include a virtual machine (VM)/just-in-time (JIT) compiler 92 that may receive control and configuration information from a hot spot detector 96. Hot spot detector 96 may be coupled to a profile controller 94, which in turn generates profiles from collected data and provides it to a profile buffer 98. The profile data may be passed from profile buffer 98 to VM/JIT compiler 92 for use in driving optimizations, for example, managed run time environment (MRTE) code optimizations. Thus DPGO system 90 consumes the data collected by profiling software 80 to identify optimization opportunities within the currently executing code.

In various embodiments, profiling software 80 programs a light-weight, user-level control yield mechanism in processor 10 to monitor specific hardware events (i.e., scenarios). When a scenario triggers (i.e., yields), the processor calls a service routine, which itself may be within profiling software 80. The service routine may collect information about the hardware's state and buffer it for later delivery to, for example, DPGO system 90. The service routine may also act on the information directly before returning to the planned stream of execution. The light-weight control yield, i.e., an asynchronous transfer, may cause a transfer from the planned stream of execution in a software thread to a service routine function defined by a channel and back to the planned stream of execution without operating system (OS) involvement. In other words, this user-level interrupt bypasses the OS entirely, enabling finer grained communication and synchronization transparently to the OS. Thus, an interrupt caused upon triggering of a scenario (e.g., a yield) is handled internally by user-level software. Accordingly, there is no external interrupt to the OS from the user-level software and the yield mechanism is performed in a single privilege level. For example, OS activities may be implemented in a first privilege level (e.g., a ring 0) while user-level activities may be implemented in a second privilege level (e.g., a ring 3). Using embodiments of the light-weight yield mechanism, upon a yield event control may pass from one ring 3 program directly to another function in the same ring 3 program, avoiding the need for drivers or other mechanisms to cause an OS visible interrupt.

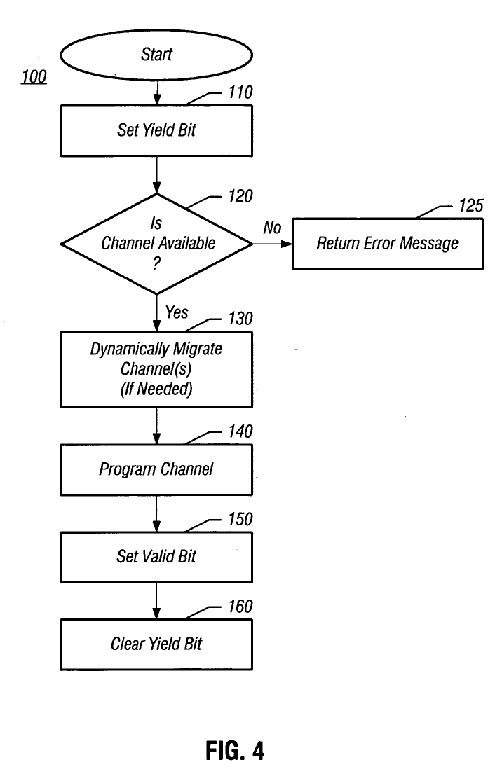

Referring now to FIG. 4, shown is a flow diagram of a method in accordance with one embodiment of the present invention. As shown in FIG. 4, method 100 may be used, e.g., by a monitor to program a channel according to one embodiment of the present invention. As shown in FIG. 4, method 100 may begin by setting the yield block bit (YBB) to prevent yields while programming a channel (block 110). In one embodiment, an EWYB instruction may be used to set the YBB. When the YBB is set the yield mechanism is locked, and yields may be prevented from occurring on all channels of a specific ring level. Thus, the YBB may be set in a multiple channel hardware implementation to ensure that one channel does not yield while another channel is being programmed. For example, suppose software has started programming channel 0 when channel 1 yields. The service routine associated with channel 1 executes. If channel 1's service routine modifies channel 0's state, channel 0's state may be changed and/or corrupted by channel 1's service routine without knowledge of the software desiring programming of channel 0. Setting the YBB bit before programming channel 0 may prevent this from occurring.

Still referring to FIG. 4, next it may be determined whether there is an available channel (block 120). In some embodiments, a channel is considered available when its valid bit is clear. In some implementations, a routine may be executed to read the valid bit on each channel. The number of channels present in a particular processor can be discovered via the CPUID instruction, for example. Table 1 below shows an example code sequence for finding an available channel in accordance with an embodiment of the present invention.

TABLE 1

```
int available_channel = −1;
if (YBB is not already set)
{
  Set YBB
  for (int i=0; i<numChannels; i++)
  {
      setup ECX; // channel ID = i, match bit = 0,
                  // ring level = current ring level
      EREAD
      check ECX;
      if (valid bit == 0)
      {
        available_channel = i;
        i = numChannels; // break out of for loop
        break;
      }
  }
}
if (available_channel == −1)
{
  // initialization failed
}
```

As shown in Table 1, first the YBB is set, and then a register (i.e., ECX) may be set up and an instruction to read the current channel (i.e., EREAD) may be executed to determine whether the current channel is available. Specifically, if the valid bit of the current channel equals zero the current channel is available and accordingly, the routine of Table 1 is exited and the value of the available channel is returned. Note that by setting a match bit to zero, processor state information is not written during the EREAD instruction in routine of Table 1.

Referring back to FIG. 4, if it is determined at diamond 120 that no channel is available, control may pass to block 125. There, if an available channel cannot be found, a message such as an error message may be returned to the entity trying to use the resource, in certain embodiments (block 125). If instead it is determined at diamond 120 that a channel is available, next control passes to block 130. There, one or more channels may be dynamically migrated, if necessary (block 130). In a multiple channel environment, one or more scenarios may be moved to a different channel depending on channel priorities, referred to herein as dynamic channel migration (DCM). Dynamic channel migration allows scenarios to be moved from one channel to another when desired. Suppose a specific implementation supports two channels, a channel 0 and a channel 1, where channel 0 is the highest priority channel. Also, suppose that channel 0 is currently being used (i.e., its valid bit is set) and channel 1 is available (i.e., its valid bit is clear). If a monitor determines that a new scenario is to be programmed into the highest priority channel and that the new scenario will not cause any problems to the scenario currently programmed into the highest priority channel if it is moved to a lower priority channel, dynamic channel migration may occur. For example, scenario information currently programmed into channel 0 may be read and then that scenario information may be reprogrammed into channel 1.

Still referring to FIG. 4, after any dynamic channel migration, the selected channel may be programmed (block 140). Programming a channel may cause various information to be stored in the channel that is selected for association with the requesting agent. For example, a software agent may request that a channel be programmed with a particular scenario. Furthermore, the agent may request that upon a yield event corresponding to the scenario a given service routine located at a particular address (stored in the channel) is to be executed. Additionally, one or more action bits may be stored in the channel.

In some embodiments, a channel may be programmed using a single instruction, such as the EMONITOR instruction. Three choices may be involved in programming a channel, namely selecting a scenario, a sample-after value, and selecting between profiling and counting. First, a scenario may be selected that monitors a hardware event of interest. During operation, when this hardware event occurs, the hardware event may be counted if the channel is configured to count.

If the channel is to be used for profiling, a sample-after value is selected. The sample-after value describes the number of hardware events (defined by the scenario) to occur before an underflow bit is set. A yield is not taken until the underflow bit is already set and another triggering condition occurs. If a non-sampled profile is desired, the yield event is to be taken on every instance of the triggering condition, the underflow bit is pre-set to one, so that a sample is taken upon the first instance and every subsequent instance of the triggering condition. If instead a sampled profile is desired, the underflow bit can be set to zero, and the counter can be set to the sample-after value. The sample-after value choice determines when a scenario's counter will underflow and the channel will yield if the channel is configured to profile. For example, if a sample-after value of 100 is programmed, 100+2+X (where X is a small number dependent on a hardware implementation) hardware events will occur before the channel yields (that is, 100 events causes the counter to reach 0, an additional event sets the underflow bit, and one more event causes the yield to occur.)

Finally, programming may select between counting events and/or profiling based on the event. Counting events can be used to characterize the behavior of the processor. Profiling based on a hardware event can be used to determine what code the processor was executing when the yield occurred. In some embodiments, counting may be a lower-overhead operation than profiling. If counting is selected, the action bits can be set to 0 (e.g., such that yields will not occur) and the sample-after value set to the maximum value (e.g., 0×7FFFFFFF). If profiling is selected, the action bits can be set to 1 (e.g., causing a yield). Upon programming a channel, the valid bit may be set to indicate that the channel has been programmed (block 150). In some implementations, the valid bit may be set during programming (e.g., via a single instruction that programs the channel and sets the valid bit). Finally, the yield bit set prior to programming may be cleared (block 160). While described with this particular implementation in the embodiment of FIG. 4, it is to be understood that programming of one or more channels may be handled differently in other embodiments.

The following pseudo-code sequence illustrates how to program a channel in accordance with one embodiment. As shown in Table 2, first multiple registers may be loaded with desired channel information. Then a single instruction, namely an EMONITOR instruction in the x86 ISA may program the selected channel with the information. As shown in Table 2 the EAX, EBX, ECX, and EDX registers may first be set up before calling a programming instruction such as the EMONITOR instruction.

TABLE 2

| | |
|---|---|
| setup EAX; | // EAX contains the sample-after value |
| | // for the scenario. |
| setup EBX; | // EBX contains the service routine address. |
| setup ECX; | // ECX contains the scenario ID, action bit, |
| | // ring level, channel ID, and the valid bit |
| setup EDX; | // EDX contains scenario-specific hints to |
| | // the EMONITOR instruction |
| EMONITOR | // EMONITOR programs the channel with above data |

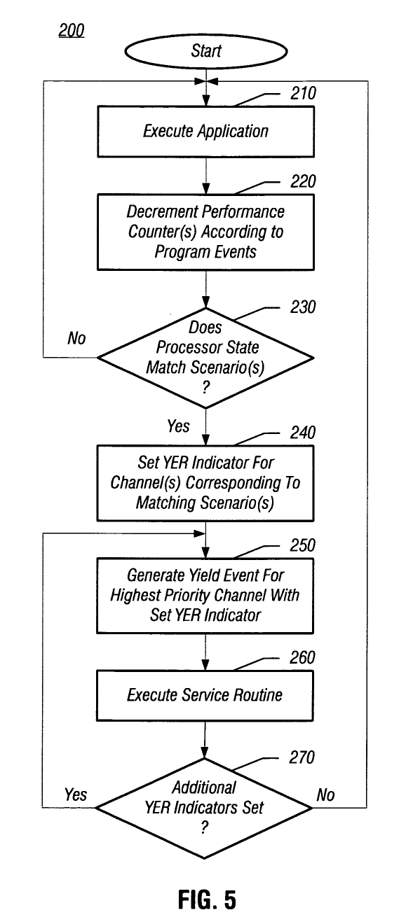

Referring now to FIG. 5, shown is a flow diagram of a method for using programmed channels in accordance with an embodiment of the present invention. As shown in FIG. 5, method 200 may begin executing an application, for example a user application (block 210). During execution of the application, various actions are taken by the processor. At least some of these actions (and/or events) occurring in the processor may impact one or more performance counters or other such monitors within the processor. Accordingly, when such instructions occur that affect these counters or monitors, performance counter(s) may be decremented according to these program events (block 220). Next, it may be determined whether current processor state matches one or more scenarios (diamond 230). For example, a performance counter corresponding to cache misses may have its value compared to a selected value programmed in one or more scenarios in different channels. If the processor state does not match any scenarios, control passes back to block 210.

If instead at diamond 230 it is determined that processor state matches one or more scenarios, control passes to block 240. There, a yield event request (YER) indicator for the channel or channels corresponding to the matching scenario(s) may be set (block 240). The YER indicator may thus indicate that the associated scenario programmed into a channel has met its composite condition.

Accordingly, the processor may generate a yield event for the highest priority channel having its YER indicator set (block 250). When a channel is programmed to profile, it will yield when its scenario triggers. This yield event transfers control to a service routine having its address programmed in the selected channel. Accordingly, next the service routine may be executed (block 260). Implementations of executing a service routine will be discussed further below. Note that, prior to calling the service routine, i.e., during a yield, the processor may push various values onto a user stack, where at least some of the values are to be accessed by the service routine(s). Specifically, in some embodiments the processor may push the current instruction pointer (EIP) onto the stack. Also, the processor may push control and status information such as a modified version of a condition code or conditional flags register (e.g., an EFLAGS register in an x86 environment) onto the stack. Still further the processor may push the channel ID of the yielding channel onto the stack.

Upon completion of the service routine, it may be determined whether additional YER indicators are set (diamond 270). If not, method 200 may return to block 210, discussed above. If instead additional YER indicators are set, control may pass from diamond 270 back to block 250, discussed above.

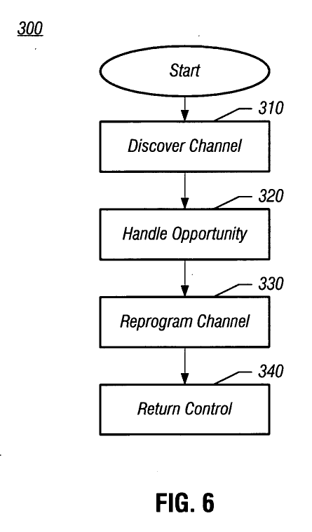

In different embodiments, service routines may take many different forms. Some service routines may be used to collect profile data, while other service routines may be used to improve program performance, e.g., via prefetching data. In any event, a service routine may execute certain high-level functions. Referring now to FIG. 6, shown is a flow diagram of a method of executing a service routine in accordance with one embodiment of the present invention. As shown in FIG. 6, method 300 may begin by discovering a yielding channel (block 310). In various embodiments, the service routine may pop the most recent value (i.e., the channel ID) off the stack. This value will map to the channel that yielded and may be used as the channel ID input for various actions or instructions during a service routine, such as collecting data and/or reprogramming the channel.

Still referring to FIG. 6, next the opportunity presented by the yielding channel may be handled by the service routine (block 320). Handling the opportunity may take different forms depending on the usage model. For example, a service routine may execute code to take advantage of the current state of the processor (as defined by the scenario definition), collect some data, or read the channel state.

When collecting data, a decision is made between collecting channel state data only or collecting channel and processor state data. The following pseudo-code sequence shown in Table 3 illustrates an embodiment of collecting data. Of course, other implementations are possible.

TABLE 3

| | |
|---|---|
| setup EAX; | // EAX contains a buffer pointer, (for collecting |
| | // processor state data) |
| setup ECX; | // ECX contains the scenario ID, match bit, |
| | // ring level, and discovered channel ID |
| | // (if the scenario ID input matches the |
| | // scenario ID currently programmed into |
| | // the channel and the match bit is set, |
| | // processor state data will be collected) |

| EREAD | |
|---|---|
| suspend_flag = 0; | |
| error_flag = 0; | |
| read EAX; | // EAX contains the current hardware event count |
| // EBX contains the service routine address originally | |
| // programmed into the channel via EMONITOR | |
| read ECX; | // ECX contains the channel's current scenario |
| | // ID, action, ring level, channel ID, and |
| | // valid bit values |

```
if (ECX is not programmed as expected)
{
      // Channel has been stolen; and take appropriate steps to
      //report/resolve problem
// (e.g. shut down or reprogram the channel)
      //  and skip recording sample data
      error_flag = 1
}
if (collecting processor state data and error_flag == 0)
{
    // [EAX] contains processor state data defined by
    //  the scenario ID
    adjust buffer pointer to move past processor
    state data collected;
    // determine if next sample will fit in buffer
    if (buffer pointer + sample size >= buffer end)
    {
      set flag indicating data is ready;
      // continue collection by using a different
      //  buffer or suspend and wait for the current
      //  buffer to be processed by the optimization
      //  subsystem
      // continue collection
      buffer pointer = a different buffer pointer;
        OR
      // suspend collection
      suspend flag = 1;
    }
}
```

With reference still to FIG. 6, next, the channel may be reprogrammed (block 330). While shown in the embodiment of FIG. 6 as including this block, it is to be understood that reprogramming may not be needed in many embodiments. However, when implemented, reprogramming may occur after data collection. More specifically, a channel may be re-programmed to reset its sample-after value. If the channel is not re-programmed, the underflow bit set when the channel originally underflowed may remain set and the channel will yield every time a hardware event satisfying the scenario definition occurs. Also, note that the YER bit may not be set when re-programming the channel. To re-program the channel, the EMONITOR instruction may be used after certain registers, such as the EAX, EBX, ECX, and EDX registers are set up. Note that the EBX, ECX, and EDX register values returned from EREAD earlier can be saved and reused during the EMONITOR instruction. The YER bit may be cleared during the transition into the service routine. Shown in Table 4 is example pseudo-code for re-programming a channel in accordance with one embodiment.

TABLE 4

| | |
|---|---|
| setup EAX; | // EAX contains the sample-after value |
| | // for the scenario. |
| setup EBX; | // EBX contains the service routine address |
| setup ECX; | // ECX contains the scenario ID, action, |
| | // ring level, channel ID discovered on |
| | // entry to the service routine, and the |
| | // valid bit (the valid bit should be set) |
| | // If the suspend flag is set, the action |
| | // bits should be set to 0 to suspend yields |
| setup EDX; | // EDX contains scenario-specific hints to |
| | // the EMONITOR instruction |
| EMONITOR | |

Finally with reference to FIG. 6, upon reprogramming (if occurring) the service routine may return control, e.g., to an original software thread that was executing when the scenario of the channel triggered (block 340). To exit a service routine, various actions may occur. In one embodiment a single instruction (e.g., an ERET instruction in an x86 ISA) may perform various functions. For example, the modified EFLAGS image pushed onto the stack during yield entry may be popped back into the EFLAGS register. Next, the EIP image pushed during the yield entry may be popped back into the EIP register. In such manner, the originally executing software thread may resume execution. Note that during exit operations, the channel ID pushed onto the stack at the beginning of the yield need not be popped off the stack. Instead, as discussed above, this stack value is popped during the service routine.

In some implementations once a yield has occurred, it is possible to determine if other yields are pending. For example, while executing the service routine for the channel that yielded, the state of the other channels can be read (e.g., via an EREAD instruction). If another channel's YER bit is set, that channel's scenario has triggered and a call to its service routine is pending. Data can be collected and the channel can be reprogrammed. The yield can remain pending if the channel's YER bit is not cleared.

Using this mechanism, it is possible to reduce service routine overhead by avoiding some transitions into service routines. But due to DCM, software cannot make assumptions about which channels it owns. A channel's service routine address can be used as a unique identifier if each channel is programmed with a different service routine. Each channel is unique within a specific software thread (assuming that channels are virtualized on a per software thread basis). Assuming that each software thread lives in the context of a single process, the service routine address is guaranteed to be unique.

Therefore, to handle multiple yields in a single service routine, each channel may be programmed with a unique service routine address. Then, before handling a pending yield, the channel's service routine address may be matched to one of the service routines previously programmed. The uniqueness of the service routine address can still be enforced if they share the same service routine code by having the first instruction in each (or all but one) service routine target be a jump or a call to the common service routine.

As described above, when a channel is programmed to count hardware events, it will not yield (since its action bits are cleared). Instead, software threads can periodically or at appropriate moments (e.g., entry/exit of a method) read the channel state to obtain its current hardware event count. Before a software thread reads a hardware event count, it must find the channel programmed with the appropriate scenario. Due to DCM, active scenarios may migrate to other channels. If a unique service routine address is programmed into each channel, the service routine address returned, e.g., via the EREAD instruction, can be used to uniquely identify the correct channel. The pseudo-code sequence shown in Table 5 may be used to find the channel currently programmed with a specific scenario and to save the current hardware event count.

TABLE 5

| int my_channel = −1; | |
|---|---|
| int my_service_routine_address = (int)service_routine; | |
| int sr; | // variable to hold service routine |
| | // address returned from EREAD |

| int count; | |
|---|---|
| for (int i=0; i<numChannels; i++) | |
| { | |
| setup ECX; | // channel ID = i, match bit = 0, |
| | // ring level = current ring level |
| EREAD | |

| | |
|---|---|
| mov count <- eax | // save the current count in case it and is |
| | // selected channel |

```
    mov sr <- ebx
    // save the ebx, ecx, and edx values in case
    // the channel needs to be re-programmed
    if (sr == my_service_routine_address)
    {
      my_channel = i;
      i = numChannels; // break out of for loop
      break;
    }
}
```

If the event count is negative, the counter has underflowed and the channel may be re-programmed. The pseudo-code sequence of Table 6 illustrates one embodiment of hardware event count accumulation and channel reprogramming (if necessary).

TABLE 6

```
// total_count: holds the accumulated count
// previous_count: holds the previous count read from the
//channel
total_count = previous_count − count;
previous_count = count;
if (count < 0)
{
    // channel has underflowed, re-program it
    // EAX contains the sample-after value
    mov eax <- 0x7FFFFFFF
    // restore saved ebx, ecx, and edx values
    EMONITOR
    previous_count = 0x7FFFFFFF;
}
```

The above code assumes the channel will be read before multiple underflows occur. If multiple underflows is a possibility, the action bits can be set to 1 and a service routine can be used to handle an underflow when it occurs.

Sometimes, pausing data collection may be desired. Pausing a profiling collection can be done in two different ways. To pause a collection completely, the action bits may be cleared in the appropriate channel. When the action bits are clear, the channel will continue to count but will not yield. To resume the collection, the appropriate channel's action bits may be set to 1. In order not to distort sampling intervals, the count value may be saved upon a pause, and restored when the channel usage is continued. If the YER bit of a channel was set while the channel is paused, a yield will not occur. Another mechanism to pause a profiling collection is to skip data collection in the service routine. In other words, an instruction to read the data is not invoked during a service routine when a collection is paused. The first mechanism, clearing the action bits, may result in less overhead compared to the second mechanism, as service routines are not executed. To stop collection completely, in some embodiments a single instruction to clear the valid bit in a channel may stop a profiling and/or counting collection. Once a channel's valid bit is cleared, that channel is free to be used by any other software.

If a service routine does a large amount of work, the service routine itself may be profiled. To profile a service routine, the YBB may be cleared during the execution of a service routine to allow the hardware to count and/or yield when a scenario triggers while the service routine executes. Two mechanisms can be used to clear the YBB. First, an instruction, e.g., the EWYB instruction in the x86 ISA, designed to write the YBB may be used to clear the YBB directly. Second, a different instruction, e.g., an ERET instruction in the x86 ISA, implicitly clears the YBB when it is invoked. The pseudo-code sequence of Table 7 illustrates how to clear the YBB before exiting a service routine in accordance with one embodiment.

TABLE 7

| void ServiceRoutine(void) | |
|---|---|
| { | |
| pop channel // pop the channel ID off of the stack | |
| setup registers for EREAD; | |
| EREAD | // EREAD before releasing the YBB lock |
| | // to avoid losing the processor state |
| | // information in effect when the channel |
| | // yielded |

| // re-program the channel next so we can re-use register | |
|---|---|
| // values returned from EREAD | |
| setup registers for EMONITOR; | |
| EMONITOR | |
| // ERET will pop two values off of the stack | |
| // flags and the EIP. Push values for these | |
| // registers. | |
| push 0 | // push dummy flags, these will get popped |
| | // by the first ERET instruction |
| mov eax <- eip | // manipulate the value of the |
| | // current EIP register to point |
| | // at the EIP after the ERET instruction |
| add eax <- XYZ | // XYZ is the size in bytes of this add |
| | // instruction plus the following push |
| | // instruction plus the following ERET |
| | // instruction |
| push eax | |
| ERET | // clears the YBB, pops the next EIP and |
| | // previously pushed flags, thus |
| | // service routine continues with YBB |
| | // cleared for continued monitoring |

```
    do work that needs to be monitored here;
    ERET
}
```

To profile a service routine, the channel may be reprogrammed to use a different scenario and/or a small sample-after value to ensure the channel yields within the execution of the profiled part of the service routine. Or a second channel may be programmed with a small sample-after value as soon as the first channel yields. As soon as the YBB is cleared in the first channel, both channels would be active.

Many profile collection usage models allow scenarios to be multiplexed and/or the sample-after value used by a specific scenario to be modified at runtime. Other runtime modifications of channel state are also possible. To change a channel's state, the following sequence of operations may be implemented, in one embodiment: (1) set the YBB (in a multiple channel hardware implementation); (2) find the channel; (3) re-program the channel; and (4) clear the YBB (if set).

In addition, channels can be saved, re-programmed, and later restored to their original state. Thus the channel to be reprogrammed may have its state saved using, e.g., the EREAD instruction. After reprogramming and during execution, the software thread may be monitored during a specific code block or period of time. Upon completion of the monitoring, the YBB may be set, the reprogrammed channel found and the state restored, e.g., via the EMONITOR instruction using the values originally saved.

In many embodiments, two different types of scenarios exist: trap-like scenarios and fault-like scenarios. Trap-like scenarios execute their service routine after the instruction triggering the scenario has retired. Fault-like scenarios instead execute their service routines as soon as the scenario triggers, and then the instruction triggering the scenario is re-executed. Accordingly, in a fault-like scenario, the architectural register state before the scenario triggers is available for access during the service routine.

For example, the instruction mov eax <−[eax] will modify the original value of EAX during the execution. If a trap-like scenario triggers during execution of this instruction, the scenario's service routine will not be able to determine the value of EAX at the time the scenario triggered. But if a fault-like scenario triggered during this instruction, its service routine can determine the value of EAX at the time the scenario triggered.

If the trigger relates to a cache miss, for example, the address of the data that missed in the cache (i.e., the effective address) may be determined by using the architectural register state in effect before the instruction executed. Upon such determination, a prefetch routine may be inserted to thus optimize the application to prefetch the data, avoiding the cache miss. In some embodiments, software to calculate the effective address in the case of a fault-like scenario may be optimized, as only the memory address is needed by the service routine, and hence there is no need to decode an entire instruction. Thus, rather than using a full instruction decoder, an address decoder may use regularity in the instruction set to construct the memory address and data size.

In one embodiment, a fast initial path in the address decoder looks in a table to determine an instruction's memory reference mode. In other words, various instructions of an instruction set have similar memory reference modes. For example, sets of instructions may request the same length of information, or may push or pop data off a stack or the like. Accordingly, based on instruction type, efficient linear address decoding may be provided. The table entry may further include information regarding data to be obtained from the instruction for use in decoding the address. It then dispatches to a selected code fragment to construct the address for the faulting instruction. The table may be organized to ensure that common dispatch paths share cache lines, improving efficiency of sequential decodes. Accordingly, in various embodiments an instruction may be efficiently decoded to obtain linear address information, while ignoring an opcode portion of the instruction. Furthermore, the decoding may be performed rapidly in the context of a service routine, significantly reducing the expense of performing the data collection. Furthermore, this address decoding may be done in the context of the service routine itself (i.e., dynamically, in real-time), avoiding the expense of saving a significant amount of data capture and later performing full decoding, which is also an expensive process. In some embodiments, the address information obtained may be used to insert a prefetch into the code or to place the data at a different location in memory to reduce the number of cache misses. Alternately, the address information may be provided as information to the application.

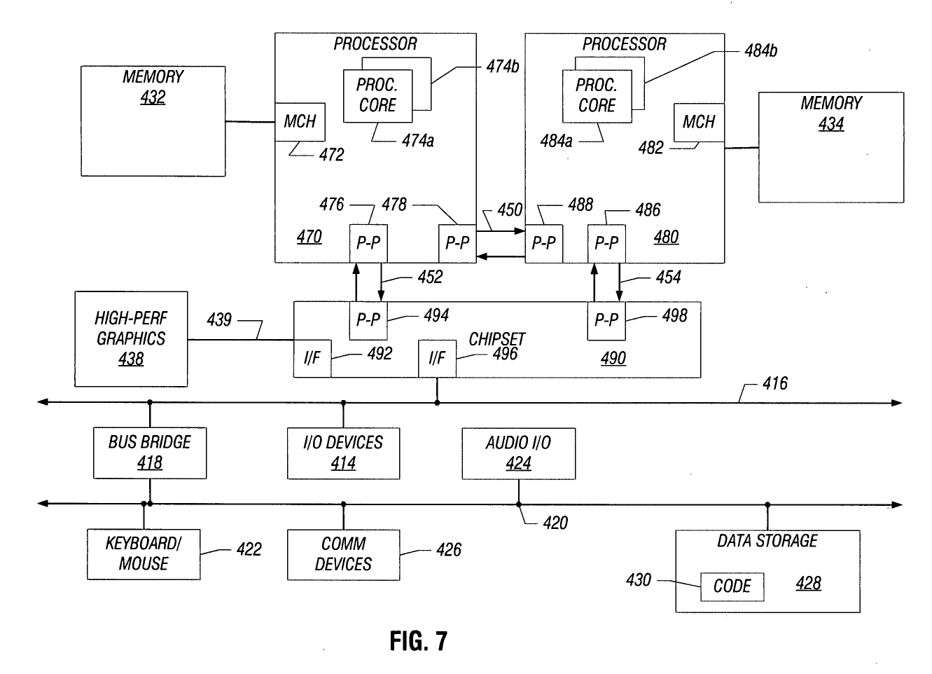

Implementations may be used in architectures running managed run time applications and server applications, as examples. Referring now to FIG. 7, shown is a block diagram of a multiprocessor system in accordance with an embodiment of the present invention. As shown in FIG. 7, the multiprocessor system is a point-to-point interconnect system, and includes a first processor 470 and a second processor 480 coupled via a point-to-point interconnect 450. As shown in FIG. 7, each of processors 470 and 480 may be multicore processors, including first and second processor cores (i.e., processor cores 474a and 474b and processor cores 484a and 484b). While not shown for ease of illustration, first processor 470 and second processor 480 (and more specifically the cores therein) may include multiple channels as described herein. First processor 470 further includes a memory controller hub (MCH) 472 and point-to-point (P-P) interfaces 476 and 478. Similarly, second processor 480 includes a MCH 482 and P-P interfaces 486 and 488. As shown in FIG. 7, MCH's 472 and 482 couple the processors to respective memories, namely a memory 432 and a memory 434, which may be portions of locally attached main memory.

First processor 470 and second processor 480 may be coupled to a chipset 490 via P-P interfaces 452 and 454, respectively. As shown in FIG. 7, chipset 490 includes P-P interfaces 494 and 498. Furthermore, chipset 490 includes an interface 492 to couple chipset 490 with a high performance graphics engine 438. In one embodiment, an Advanced Graphics Port (AGP) bus 439 may be used to couple graphics engine 438 to chipset 490. AGP bus 439 may conform to the Accelerated Graphics Port Interface Specification, Revision 2.0, published May 4, 1998, by Intel Corporation, Santa Clara, Calif. Alternately, a point-to-point interconnect 439 may couple these components.

In turn, chipset 490 may be coupled to a first bus 416 via an interface 496. In one embodiment, first bus 416 may be a Peripheral Component Interconnect (PCI) bus, as defined by the PCI Local Bus Specification, Production Version, Revision 2.1, dated June 1995 or a bus such as the PCI Express bus or another third generation input/output (I/O) interconnect bus, although the scope of the present invention is not so limited. As shown in FIG. 7, various I/O devices 414 may be coupled to first bus 416, along with a bus bridge 418 which couples first bus 416 to a second bus 420. In one embodiment, second bus 420 may be a low pin count (LPC) bus. Various devices may be coupled to second bus 420 including, for example, a keyboard/mouse 422, communication devices 426 and a data storage unit 428 which may include code 430, in one embodiment. Further, an audio I/0 424 may be coupled to second bus 420.

Collecting profiling information with the mechanisms described above allows for low-overhead, on-line profiling and dynamic compilation. Embodiments of the light-weight control yield mechanism and its application to user-level interrupts may thus bypass the OS entirely, enabling finer-grained communication and synchronization, in a way that is transparent to the OS. Thus in various embodiments, no OS support is needed to collect and use profile information, avoiding the OS for programming and taking interrupts. Accordingly, the yield mechanisms need no device drivers, no new OS application programming interfaces (APIs), and no new instructions in context switch code. Profile data obtained using embodiments of the present invention may be used for dynamic optimizations, such as re-laying out code and data and inserting prefetches.

Embodiments may be implemented in code and may be stored on a storage medium having stored thereon instructions which can be used to program a system to perform the instructions. The storage medium may be any of various media such as disk, semiconductor device such as read-only memories (ROMs), random access memories (RAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
executing uninstrumented code in a managed run-time environment (MRTE);
monitoring at least one hardware event using a resource of a processor during execution of the uninstrumented code in a privilege level; and
collecting profile information in the privilege level corresponding to the at least one hardware event upon occurrence of a trigger condition.

2. The method of claim 1, further comprising programming the resource with the at least one hardware event and the trigger condition, wherein the resource comprises a channel.

3. The method of claim 1, wherein collecting the profile information comprises asynchronously calling a service routine from the uninstrumented code upon the occurrence of the trigger condition.

4. The method of claim 3, further comprising transferring control to the service routine in the privilege level.

5. The method of claim 1, further comprising executing the uninstrumented code in a user-level privilege level corresponding to the privilege level.

6. The method of claim 3, further comprising handling at least one other trigger condition associated with a different hardware event via the service routine.

7. The method of claim 1, further comprising reading a count associated with the at least one hardware event without the occurrence of the trigger condition.

8. The method of claim 1, further comprising pausing collecting the profile information while continuing to monitor the at least one hardware event.

9. The method of claim 1, further comprising modifying the trigger condition during execution of the uninstrumented code.

10. The method of claim 3, wherein collecting the profile information comprises obtaining architectural state information of the processor before an instruction that causes the occurrence of the trigger condition.

11. The method of claim 10, further comprising determining, in the service routine, an effective address for a memory location associated with the instruction based on a portion of the instruction and the architectural state information.

12. The method of claim 11, further comprising determining the effective address in real-time without storing the architectural state information.

13. The method of claim 3, further comprising profiling the service routine.

14. An article comprising a machine-accessible medium having instructions that when executed cause a system to:
monitor at least one hardware event during execution of an application;
indicate a yield event when a condition associated with the at least one hardware event is triggered; and
transfer control from the application to a yield event routine upon the indication without operating system (OS) intervention.

15. The article of claim 14, further comprising instructions that when executed cause the system to program a storage of a processor with information regarding the condition, the information including the at least one hardware event, a trigger for the condition, and an address for the yield event routine.

16. The article of claim 15, further comprising instructions that when executed cause the system to access the storage to collect profile information stored in the processor via the yield event routine.

17. The article of claim 16, further comprising instructions that when executed cause the system to buffer the profile information in a profile buffer for access by a code optimization system.

18. A method comprising:
receiving a request to use a processor channel of a processor by an application for collection of profile data during execution of the application;
selecting one of a plurality of processor channels for the use; and
programming the selected channel with a scenario.

19. The method of claim 18, further comprising receiving control information related to the scenario and storing the control information in the selected channel.

20. The method of claim 18, wherein the selecting comprises determining an available one of the plurality of processor channels.

21. The method of claim 18, further comprising identifying one or more hardware events for which to collect the profile data and setting a sample value corresponding to a counter value upon which the scenario is to trigger.

22. The method of claim 18, further comprising collecting the profile data from the channel via a service routine directly called by the processor when the scenario triggers.

23. A system comprising:
an optimization unit to optimize a code segment, the optimization unit including a compiler and a profile controller; and
a profiler coupled to the optimization unit to request programming of a channel with a scenario for collection of profile data during execution of the code segment.

24. The system of claim 23, wherein the profiler is to transfer control from the code segment to a service routine upon a trigger for the scenario.

25. The system of claim 24, wherein the profiler is to transfer the control without operating system (OS) intervention.

26. The system of claim 23, wherein the compiler comprises a just-in-time (JIT) compiler and the optimization unit further comprises a profile buffer coupled to the JIT compiler to store the collected profile data.

27. The system of claim 23, wherein the optimization unit is to insert a prefetch routine into the code segment based upon analysis of the profile data collected upon a trigger for the scenario caused by an instruction of the code segment.

28. The system of claim 27, wherein the profiler is to determine an effective address associated with the instruction without decoding the instruction.

29. The system of claim 27, wherein an architectural state of the system prior to execution of the instruction is available after the trigger.
